(19) United States
(12) Patent Application Publication
(10) Pub. No.: US 2008/0150841 A1
(43) Pub. Date: Jun. 26, 2008

(54) Plasma display panel and method of driving the same

(76) Inventors: Kazuhiro Ito, Suwon-si (KR); Won-Joon Lee, Suwon-si (KR); Tae-Wook Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/985,155

(22) Filed: Nov. 13, 2007

(30) Foreign Application Priority Data
Dec. 20, 2006 (KR) 10-2006-0130828

(51) Int. Cl. G09G 3/28

(52) U.S. Cl. 345/68

(57) ABSTRACT

A method of driving a plasma display panel and a plasma display panel are disclosed. The method includes driving the panel with a reset period, which is either a main reset period, during which a decreasing pulse is applied to Y electrodes after increasing the pulse from a first voltage to a second voltage, or a sub reset period, during which a decreasing pulse is applied to the Y electrodes after increasing the pulse from the first voltage to a third voltage, where the third voltage is lower than the second voltage. Also, a fifth voltage and a fourth voltage are applied to the Y electrodes and the X electrodes during the sustain period, wherein the third voltage is lower than the fifth voltage.

### CROSS-REFERENCE TO RELATED PATENT APPLICATION

This application claims the benefit of Korean Patent Application No. 10-2006-0130828, filed on Dec. 20, 2006, in the Korean Intellectual Property Office, the disclosure of which is incorporated herein in its entirety by reference.

### BACKGROUND

1. Field of the Invention

The present invention relates to a plasma display panel and a method of driving the same, and more particularly, to a plasma display panel wherein occurrences of an erroneous discharge is reduced, and a method of driving the same.

2. Description of the Related Technology

A plasma display panel (PDP) is a flat display device having a wide screen, and displays a desired image by applying a discharge voltage to two substrates each having a plurality of electrodes, wherein discharge gas is entrapped between the two substrates and used to generate ultraviolet radiation which excites a phosphor pattern.

A driving device of a PDP includes a plurality of power sources, a plurality of switching devices, and a plurality of driving integrated circuits (ICs) which control switching operations of the switching devices, in order to apply driving signals to each of a plurality of electrodes disposed in the PDP. The driving device of the PDP outputs the driving signals by the switching operations of the plurality of switching devices.

Generally, in a PDP, one frame is divided into a plurality of subfields, and a gray scale is expressed by combining the subfields. Each subfield includes a reset period, an address period, and a sustain period. During the reset period, wall charge formed during the previous sustain discharge is removed, and wall charge for stably performing the next address discharge is induced. During the address period, cells to be turned on and cells not to be turned on are selected, and wall charge is accumulated in the cells to be turned on (addressed cells). During the sustain period, sustain discharge occurs in the addressed cells in order to display an image.

During the reset period of each subfield, a reset waveform having the form of a rising ramp and a falling ramp is applied to a Y electrode. The rising ramp generates a weak discharge, and the falling ramp makes wall charges of all cells have the same condition. However, cells not selected in the previous subfield do not generate discharge during the sustain period, and thus wall charges set up during the reset period of the previous subfield are maintained. Accordingly, wall charges are not required to be accumulated by applying the rising ramp during the reset period.

Thus, after resetting the main reset waveform having a rising ramp and a falling ramp during the reset period of the first subfield, a sub reset waveform which applies either a rising ramp or a falling ramp during a reset period can be applied during predetermined subfields.

However, in the conventional driving waveforms as described above, the peak of the sub reset waveform is set up to be the same as or greater than the sustain voltage. Accordingly, discharge occurs spontaneously during the sub reset period, and erroneous discharge occurs to sustain pulse in the next subfields. Accordingly, the quality of an image deteriorates.

### SUMMARY OF CERTAIN INVENTIVE ASPECTS

Certain aspects provide a plasma display panel in which discharge that is not required is prevented by removing a malfunction during a reset period, and a method of driving the same.

One aspect is a method of driving a plasma display panel including discharge cells formed near areas where address electrodes cross pairs of sustain electrodes, where the sustain electrodes include X electrodes and Y electrodes configured to be parallel to each other. The method includes dividing a frame into a plurality of subfields for displaying time ratio gray scale, dividing each subfield into a reset period, an address period, and a sustain period, where the reset period includes either a main reset period, during which a decreasing signal is applied to the Y electrodes after a signal increasing from a first voltage to a second voltage is applied to the Y electrodes, or a sub reset period, during which the decreasing signal is applied to the Y electrodes after a signal increasing from the first voltage to a third voltage is applied to the Y electrodes, where the third voltage is lower than the second voltage, and applying a fourth voltage and a fifth voltage to the Y electrodes and the X electrodes during the sustain period, where the third voltage is lower than the fifth voltage.

Another aspect is a plasma display panel including a first substrate and a second substrate spaced apart from each other and facing each other, X electrodes and Y electrodes crossing discharge cells, where the discharge cells are formed between the first and second substrates and are configured to generate discharge, address electrodes crossing the discharge cells substantially perpendicular to the X and Y electrodes, and a panel driver configured to apply a driving signal to the X, Y, and address electrodes, where the driving signal includes a frame including a plurality of subfields for displaying time ratio gray scale, each subfield including a reset period, an address period, and a sustain period, where the reset period includes either a main reset period, during which a decreasing signal is applied to the Y electrodes after a signal increasing from a first voltage to a second voltage is applied to the Y electrodes, or a sub reset period, during which the decreasing signal is applied to the Y electrodes after a signal increasing from the first voltage to a third voltage is applied to the Y electrodes, where the third voltage is lower than the second voltage and where a fourth voltage and a fifth voltage are applied to the X and Y electrodes during the sustain period, where the third voltage is lower than the fifth voltage.

### BRIEF DESCRIPTION OF THE DRAWINGS

The above and other features and advantages will become more apparent by describing certain embodiments with reference to the attached drawings in which:

FIG. 1 is a diagram illustrating a plasma display panel driven by a method according to one embodiment;

FIG. 2 is a cross-sectional view illustrating a unit display cell of the plasma display panel of FIG. 1;

FIG. 3 is a diagram illustrating electrodes disposed in the plasma display panel of FIG. 1;

FIG. 4 is a block diagram briefly illustrating a driving device for driving the plasma display panel of FIG. 1;

FIG. 5 is a timing diagram describing a method of driving the plasma display panel of FIG. 1;

FIG. 6 is a timing diagram illustrating driving signals output to electrodes using a method of driving a plasma display panel according to an embodiment; and

FIG. 7 is a timing diagram illustrating driving signals output to electrodes using a method of driving a plasma display panel according to another embodiment.

### DETAILED DESCRIPTION OF CERTAIN INVENTIVE EMBODIMENTS

Hereinafter, the certain embodiments will be described more fully with reference to the accompanying drawings, in which embodiments of the invention are shown.

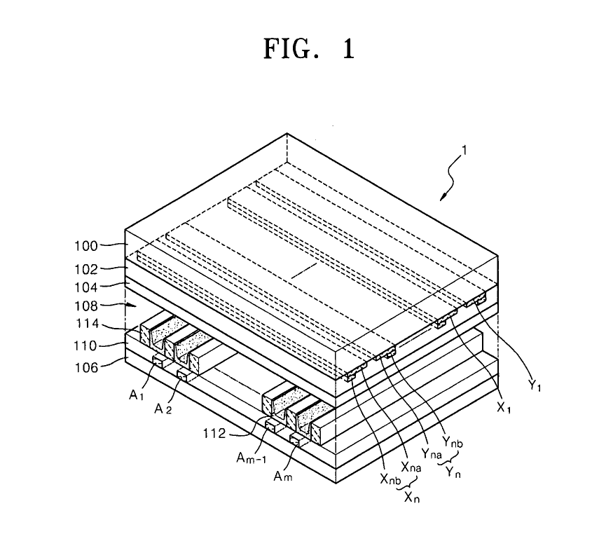

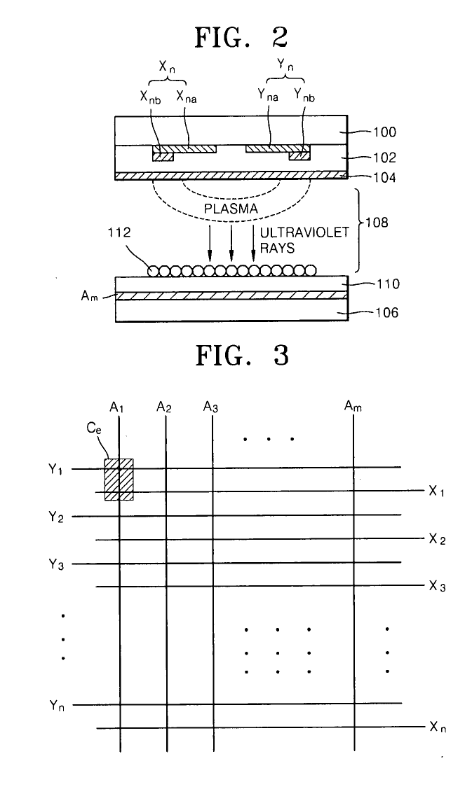

FIG. 1 is a diagram illustrating a plasma display panel 1 driven by a method according to an embodiment. FIG. 2 is a cross-sectional view illustrating a unit display cell of the plasma display panel 1 of FIG. 1.

Referring to FIGS. 1 and 2, A electrodes A1 through Am, a first dielectric layer 102, a second dielectric layer 110, Y electrodes Y1 through Yn, X electrodes X1 through Xn, phosphor layers 112, barrier ribs 114, and a magnesium monoxide (MgO) protective layer 104 are formed between a first substrate 100 and a second substrate 106 of the plasma display panel 1.

The A electrodes A1 through Am are formed in a uniform pattern on a side of the second substrate 106 facing towards the first substrate 100. The second dielectric layer 110 is coated on the A electrodes A1 through Am. The barrier ribs 114 are formed on the second dielectric layer 110, parallel to the A electrodes A1 through Am. The barrier ribs 114 define a discharge area of each discharge cell, and prevent optical interference between the discharge cells. The phosphor layers 112 are coated on the second dielectric layer 110 on the A electrodes A1 through Am between the barrier ribs 114. Phosphor layers emitting red light, green light, and blue light may be sequentially disposed.

The X electrodes X1 through Xn and the Y electrodes Y1 through Yn are formed in a uniform pattern on a side of the first substrate 100 facing toward the second substrate 106, and run at right angles to the A electrodes A1 through Am. Each crossing point occurs near a corresponding discharge cell. Each of the X electrodes X1 through Xn and each of the Y electrodes Y1 through Yn can be formed by combining transparent electrodes Xna and Yna formed of a transparent conductive material such as indium tin oxide (ITO), etc, and metal electrodes Xnb and Ynb having high conductivity. The first dielectric layer 102 may be coated on the entire surface of the X electrodes X1 through Xn and the Y electrodes Y1 through Yn. The protective layer 104, for protecting the plasma display panel 1 from strong electric fields, such as an MgO layer may be coated on the entire surface of the first dielectric layer 102. Gas for forming plasma is sealed in a discharge space 108.

A plasma display panel driven using the method is not limited to the plasma display panel 1 illustrated in FIG. 1. For example, the plasma display panel may not only have a three-electrode structure as shown in FIG. 1, but may also have a two-electrode structure. Other plasma display panels having various structures can be used.

FIG. 3 is a diagram illustrating electrodes disposed in the plasma display panel 1 of FIG. 1.

Referring to FIG. 3, the Y electrodes Y1 through Yn are disposed parallel to the X electrodes X1 through Xn, the A electrodes A1 through Am are disposed substantially perpendicular to the Y electrodes Y1 and Yn and the X electrodes X1 through Xn, and the crossing areas are near discharge cells Ce.

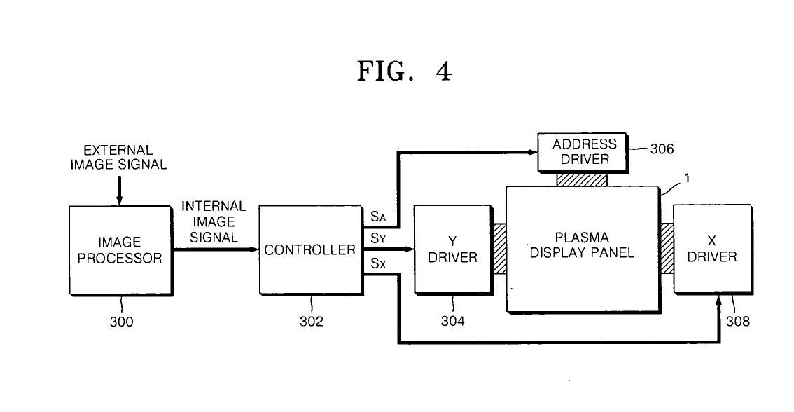

FIG. 4 is a block diagram briefly illustrating a driving device for driving the plasma display panel 1 of FIG. 1.

Referring to FIG. 4, one embodiment of a driving device of the plasma display panel 1 includes an image processor 300, a controller 302, an address driver 306, an X driver 308, and a Y driver 304. The image processor 300 converts an external analog image signal into a digital signal in order to generate an internal image signal, for example, red R, green G, and blue B image data, each having a size of 8 bits, a clock signal, a vertical synchronizing signal, or a horizontal synchronizing signal. The controller 302 generates drive control signals SA, SY, and SX based on the image signals of the image processor 300. The address driver 306 generates a display data signal by processing an address signal SA from among the drive control signals SA, SY, and SX, and applies the generated display data signal to address electrode lines. The X driver 308 processes an X drive control signal SX from among the drive control signals SA, SY, and SX from the controller 302, and applies the X drive control signal SX to X electrode lines. The Y driver 304 processes an Y drive control signal SY from among the drive control signals SA, SY, and SX from the controller 302, and applies the Y drive control signal SY to Y electrode lines.

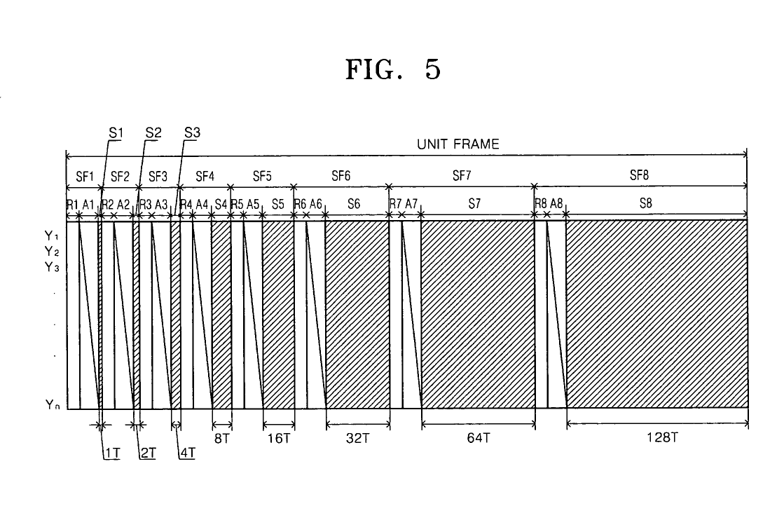

FIG. 5 is a timing diagram for describing a method of driving the plasma display panel 1 of FIG. 1.

Referring to FIG. 5, a unit frame can be classified in to a predetermined number, for example, 8 subfields SF1 through SF8, in order to realize a time ratio gray scale display. Also, the subfields SF1 through SF8 are classified into reset periods R1 through R8, address periods A1 through A8, and sustain periods S1 through S8, respectively.

In the reset periods R1 through R8, reset pulses are applied to Y electrodes Y1 through Yn, and thus all cells are initiated since wall charge conditions are the same.

During each of the address periods A1 through A8, address pulses are applied to A electrodes, and at the same time, corresponding scan pulses are sequentially applied to the Y electrodes Y1 through Yn.

During each of the sustain periods S1 through S8, sustain pulses are alternatively applied to the Y electrodes Y1 through Yn and X electrodes X1 through Xn, in order to generate sustain discharge in all of the discharge cells where wall charges are formed during the address periods A1 through A8.

The brightness of the plasma display panel 1 is in proportion to the number of sustain discharge pulses during the sustain periods S1 through S8 in a unit frame. For example, when one frame forming one image is displayed in 8 subfields and a 256-degree gray scale, different numbers of sustain pulses can be allocated to each subfield, in a ratio of 1, 2, 4, 8, 16, 32, 64, and 128 sequentially. Hence, in order to obtain brightness of a 133-degree gray scale, the cells can be addressed during the first subfield SF1, the third subfield SF3, and the eighth subfield SF8 for sustain discharge.

The number of sustain discharges allocated to each subfield can be varied based on the weighted value of the subfields in an automatic power control step. Also, the number of sustain discharges allocated to each subfield can be varied considering the gamma characteristics or properties of the plasma display panel 1. For example, the gray scale degree allocated to the fourth subfield SF4 can be decreased from 8 to 6 and the gray scale degree allocated to the sixth subfield SF6 can be increased from 32 to 34. Also, the number of subfields forming one frame can be varied based on the design specification.

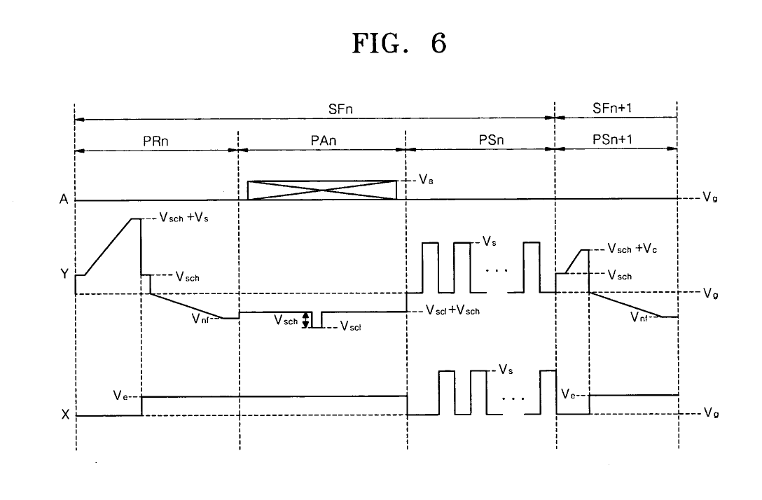

FIG. 6 is a timing diagram illustrating driving signals output to electrodes using a method of driving a plasma display panel according to an embodiment.

Referring to FIG. 6, a unit frame for driving the plasma display panel 1 of FIG. 4 is classified into a plurality of subfields SFs, and each subfield SF has a reset period PR, an address period PA, and a sustain period PS.

During a reset period PRn of a subfield SFn, main reset pulses are applied, wherein a first voltage Vsch is applied to Y electrodes Y1 through Yn after the last sustain pulse (not shown) is applied in the previous sustain period (not shown), then a voltage that increases from the first voltage Vsch to a second voltage Vsch+Vs is applied to the Y electrodes Y1 through Yn, and then a voltage that decreases from the first voltage Vsch to a sixth voltage Vnf is applied to the Y electrodes Y1 through Yn. At this time, a fourth voltage Vg, for example, a ground voltage is applied to address electrodes A1 through Am. Also, when an increasing voltage is applied to the Y electrodes Y1 through Yn, the fourth voltage Vg is applied to the X electrodes X1 through Xn. When a decreasing voltage is applied to the Y electrodes Y1 through Yn, a seventh voltage Ve is applied to the X electrodes X1 through Xn.

As described above, while a voltage increases, weak discharge occurs from the Y electrodes Y1 through Yn to the address electrodes A1 through Am and the X electrodes X1 through Xn. Due to this weak discharge, negative wall charges are accumulated in the Y electrodes Y1 through Yn and positive wall charges are accumulated in the address electrodes A1 through Am and the X electrodes X1 through Xn.

Also, while a voltage decreases, weak discharge occurs from the address electrodes A1 through Am and the X electrodes X1 through Xn to the Y electrodes Y1 through Yn by wall discharges formed in discharge cells. Due to this weak discharge, wall charges formed in the X electrodes X1 through Xn, the Y electrodes Y1 through Yn, and the address electrodes A1 through Am are partially removed which places the discharge cells in a suitable state for being addressed.

During an address period PAn, discharge cells which will perform sustain discharge during the sustain period PSn are selected by address discharge. During the address period PAn, the seventh voltage Ve is continuously applied to the X electrodes X1 through Xn, scan pulses are sequentially applied to the Y electrodes Y1 through Yn, and display data signals are applied to the address electrodes A1 through Am in accordance with the scan pulses in order to perform address discharge. The scan pulses have an eighth voltage Vscl+Vsch at first, which is then transited to a ninth voltage Vscl, which is smaller than the eighth voltage Vscl+Vsch. The display data signal has a tenth voltage Va of positive polarity, when the ninth voltage Vscl of the scan pulses are applied.

During the address period PAn, sustain discharge is generated in the selected discharge cells by the sustain pulses applied during the sustain period PSn. However, sustain discharge is not generated in discharge cells that are not selected, even if the sustain pulses are applied during the sustain period PSn.

During the sustain period PSn, the sustain pulses are alternatively applied to the X electrodes X1 through Xn and the Y electrodes Y1 through Yn in order to perform sustain discharge. The brightness of a unit field formed of a plurality of subfields depends on the sustain discharge performed based on a weighted value of a gray scale allocated to each subfield. The sustain pulses alternatively have a fifth voltage Vs and the fourth voltage Vg.

Next, during a reset period PRn+1 of a subfield SFn+1, sub reset pulses are applied to the Y electrodes Y1 through Yn, wherein the first voltage Vsch is applied after the last sustain pulse applied during the sustain period PSn, then a voltage that increases from the first voltage Vsch to the third voltage Vsch+Vc are applied, and then a voltage that decreases from the fourth voltage Vg to the sixth voltage Vnf is applied. At this time, like the main reset pulses, the fourth voltage Vg, for example, a ground voltage is applied to the address electrodes A1 through Am. Also, when an increasing ramp voltage is applied to the Y electrodes Y1 through Yn, the fourth voltage Vg is applied to the X electrodes X1 through Xn, and when a decreasing voltage is applied to the Y electrodes Y1 through Yn, the seventh voltage Ve is applied to the X electrodes X1 through Xn.

Another aspect is an address period (not shown) and a sustain period (not shown) of the subfield SFn+1 may be the same as the address period PAn and the sustain period PSn of the subfield SFn.

The third voltage Vsch+Vc of the sub reset pulses is lower than the second voltage Vsch+Vs of the main reset pulses. Also, the third voltage Vsch+Vc of the sub reset pulses is lower than the fifth voltage Vs, which is a sustain voltage applied to the X electrodes X1 through Xn and the Y electrodes Y1 through Yn during the sustain period PS.

Meanwhile, when the third voltage Vsch+Vc of the sub reset pulses is equal to or higher than the fifth voltage Vs, which is the sustain voltage applied to the X electrodes X1 through Xn and the Y electrodes Y1 through Yn during the sustain period PS, a discharge may be spontaneously generated during the sub reset period, which can cause erroneous discharge of the sustain pulses in the following subfield. Accordingly, the quality of an image may deteriorate.

In FIG. 6, the third voltage Vsch+Vc of the sub reset pulses is regulated in order to be lower than the fifth voltage Vs, which is the sustain voltage applied to the X electrodes X1 through Xn and the Y electrodes Y1 through Yn during the sustain period PS, and thus malfunctions which can be generated during a reset operation are removed. Accordingly, discharge that is not required is not generated, and thus a purer image can be displayed on a plasma display panel.

Combinations of the main reset period and the sub reset period are not specifically limited in one frame. However, the first subfield of a frame may include the main reset period, while the rest of the subfields of the frame may include the sub reset periods.

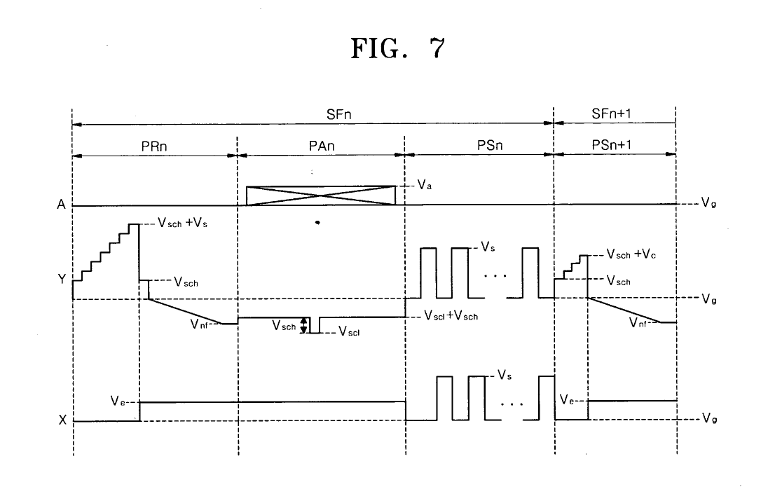

FIG. 7 is a timing diagram illustrating driving signals output to electrodes using a method of driving a plasma display panel according to another embodiment.

Referring to FIG. 7, driving signals in an address period PA and a sustain period PS are substantially the same, similar to or different from the driving signals in the address period PA and the sustain period PS of FIG. 6. However, during the reset period PA as shown in FIG. 6, stair type pulses which increase in stages are applied.

As illustrated in FIG. 7, when a stepped waveform is used as an increasing pulse of a reset period PR, possibility of weak discharge generation increases compared to when a ramp waveform of FIG. 6 is used.

By regulating the third voltage Vsch+Vc of the sub reset pulses to be lower than the fifth voltage Vs, which is the sustain voltage applied to the X electrodes X1 through Xn and the Y electrodes Y1 through Yn during the sustain period PS, discharges that are not required and can cause malfunctions during the reset operation are prevented. Accordingly, an exact image can be displayed on a plasma display panel.

Using the method of driving a plasma display panel and the plasma display panel according to the embodiments, malfunctions that can occur during a reset operation can be prevented, and thus discharges that are not required are not generated. Accordingly, an exact image can be displayed on the plasma display panel.

While the embodiments discussed have been particularly shown and described with reference to descriptive explanations thereof, it will be understood by those of ordinary skill in the art that various changes in form and details may be made therein without departing from the spirit and scope of the present invention.

What is claimed is:

1. A method of driving a plasma display panel comprising discharge cells formed near areas where address electrodes cross pairs of sustain electrodes, wherein the sustain electrodes comprise X electrodes and Y electrodes configured to be parallel to each other, the method comprising:
dividing a frame into a plurality of subfields for displaying time ratio gray scale;
dividing each subfield into a reset period, an address period, and a sustain period, wherein the reset period comprises:
either a main reset period, during which a decreasing signal is applied to the Y electrodes after a signal increasing from a first voltage to a second voltage is applied to the Y electrodes; or
a sub reset period, during which the decreasing signal is applied to the Y electrodes after a signal increasing from the first voltage to a third voltage is applied to the Y electrodes, wherein the third voltage is lower than the second voltage; and
applying a fourth voltage and a fifth voltage to the Y electrodes and the X electrodes during the sustain period,
wherein the third voltage is lower than the fifth voltage.

2. The method of claim 1, wherein the first subfield of the frame comprises the main reset period, and the rest of the subfields of the frame comprise the sub reset period.

3. The method of claim 1, wherein the increase from the first voltage to the second voltage or the increase from the first voltage to the third voltage is executed in stepped waveform.

4. The method of claim 1, wherein the fourth voltage is a ground voltage.

5. The method of claim 1, wherein the main reset period comprises:
applying the first voltage to the Y electrodes;
applying the signal increasing from the first voltage to the second voltage to the Y electrodes;
re-applying the first voltage to the Y electrodes; and
applying the signal decreasing from the first voltage to a sixth voltage to the Y electrodes.

6. The method of claim 1, wherein the sub reset period comprises:
applying the first voltage to the Y electrodes;
applying the signal increasing from the first voltage to the third voltage to the Y electrodes; and
applying the signal decreasing from the fourth voltage to the sixth voltage to the Y electrodes.

7. The method of claim 1, wherein during the reset period, the fourth voltage is applied to the address electrodes, and a seventh voltage is applied to the X electrodes when a decreasing pulse is applied to the Y electrodes.

8. The method of claim 1, wherein during the address period, the seventh voltage is continuously applied to the X electrodes, a scan pulse of a ninth voltage is applied to the Y electrodes that are biased with an eighth voltage, and a data pulse of a tenth voltage, which is synchronized with the scan pulse of the ninth voltage from the fourth voltage, is applied to the address electrodes of discharge cells that are to display.

9. The method of claim 8, wherein the data pulse is a positive pulse and the scan pulse is a negative pulse.

10. The method of claim 1, wherein during the sustain period, the fourth voltage is applied to the address electrodes.

11. A plasma display panel comprising:
a first substrate and a second substrate spaced apart from each other and facing each other;
X electrodes and Y electrodes crossing discharge cells, wherein the discharge cells are formed between the first and second substrates and are configured to generate discharge;
address electrodes crossing the discharge cells substantially perpendicular to the X and Y electrodes; and
a panel driver configured to apply a driving signal to the X, Y, and address electrodes,
wherein the driving signal comprises a frame comprising a plurality of subfields for displaying time ratio gray scale, each subfield comprising a reset period, an address period, and a sustain period,
wherein the reset period comprises:
either a main reset period, during which a decreasing signal is applied to the Y electrodes after a signal increasing from a first voltage to a second voltage is applied to the Y electrodes; or
a sub reset period, during which the decreasing signal is applied to the Y electrodes after a signal increasing from the first voltage to a third voltage is applied to the Y electrodes, wherein the third voltage is lower than the second voltage
and wherein a fourth voltage and a fifth voltage are applied to the X and Y electrodes during the sustain period, wherein the third voltage is lower than the fifth voltage.

12. The plasma display panel of claim 11, wherein the first subfield of the frame comprises the main reset period and the rest of the subfields of the frame comprises the sub reset period.

13. The plasma display panel of claim 11, wherein the increase from the first voltage to the second voltage or the increase from the first voltage to the third voltage is executed in stepped waveform.

14. The plasma display panel of claim 11, wherein the fourth voltage is a ground voltage.

15. The plasma display panel of claim 11, wherein the main reset period comprises:
applying the first voltage to the Y electrodes;
applying the signal increasing from the first voltage to the second voltage to the Y electrodes;
re-applying the first voltage to the Y electrodes; and
applying the signal decreasing from the first voltage to a sixth voltage to the Y electrodes.

16. The plasma display panel of claim 11, wherein the sub reset period comprises:
applying the first voltage to the Y electrodes;
applying the signal increasing from the first voltage to the third voltage to the Y electrodes; and
applying the signal decreasing from the fourth voltage to the sixth voltage to the Y electrodes.

17. The plasma display panel of claim 11, wherein during the reset period, the fourth voltage is applied to the address electrodes, and a seventh voltage is applied to the X electrodes while applying a decreasing pulse to the Y electrodes.

18. The plasma display panel of claim 11, wherein during the address period, the seventh voltage is continuously applied to the X electrodes, a scan pulse of a ninth voltage is applied to the Y electrodes that are biased with an eighth voltage, and a data pulse of a tenth voltage, which is synchronized with the scan pulse of the ninth voltage from the fourth voltage, is applied to the address electrodes of discharge cells that are to display.

19. The plasma display panel of claim 18, wherein the data pulse is a positive pulse and the scan pulse is a negative pulse.

20. The plasma display panel of claim 11, wherein during the sustain period, the fourth voltage is applied to the address electrodes.
